(19) United States
(12) Patent Application Publication
(10) Pub. No.: US 2014/0181685 A1
(43) Pub. Date: Jun. 26, 2014

(54) APPARATUS AND METHOD FOR CONFIGURING SCREEN OF MOBILE TERMINAL

(71) Applicant: Samsung Electronics Co., Ltd., Gyeonggi-do (KR)

(72) Inventors: Jong-Hwa LEE, Gyeonggi-do (KR); Jae-Hong LIM, Seoul (KR); Seung-Eun KIM, Gyeonggi-do (KR); Hyo-Jin CHO, Seoul (KR)

(73) Assignee: Samsung Electronics Co., Ltd., Gyeonggi-do (KR)

(21) Appl. No.: 14/136,731

(22) Filed: Dec. 20, 2013

(30) Foreign Application Priority Data
Dec. 21, 2012 (KR) 10-2012-0151204

(51) Int. Cl. G06F 3/0481; G06F 3/0484

(52) U.S. Cl. CPC G06F 3/0481; G06F 3/04842
USPC 715/747

(57) ABSTRACT

An apparatus and method for configuring a screen of a mobile terminal suitable for a user are provided. The method includes displaying an interface for configuring a screen of the mobile terminal; receiving, through the displayed interface, at least one input for configuring the screen to be suitable for a user; configuring a screen of the mobile terminal corresponding to the received at least one input; and displaying the configured screen.

### PRIORITY

This application claims priority under 35 U.S.C. §119(a) to Korean Application Serial No. 10-2012-0151204, which was filed in the Korean Intellectual Property Office on Dec. 21, 2012, the entire content of which is incorporated herein by reference.

### BACKGROUND OF THE INVENTION

1. Field of the Invention

The present invention relates generally to a mobile terminal, and more particularly, to an apparatus and a method for configuring a screen of a mobile terminal to a screen suitable for a user.

2. Description of the Related Art

With the recent popularization of smart devices, such as a smart phone, a tablet Personal Computer (PC), a smart TV, etc., various products that have convenience functions for users have been manufactured and consumed. Different users have unique propensities for consumption and behavior, manufacturers provide specialized products that reflect users' unique desires. For example, a variety of specialized products such as an “iPad” from Apple, Inc. and a “Galaxy Tab” from Samsung Electronics Co., which are tablet PCs to be universally used, a “Kindle Fire” of Amazon.com, which is specialized for an e-book, a “Leap Pad” of Leapfrog Co., which is made for toddlers or children, and a “Meep Tablet” of Oregon Co., which is made for teenagers have targeted various consumers. Hereinafter, a smart phone, a portable phone, a game player, a TeleVision (TV), a display unit, a heads-up display for a vehicle, a notebook, a laptop PC, a tablet PC, a Personal Media Player (PMP), a Personal Digital Assistant (PDA), and other such devices are referred to as mobile terminals, which include pocket-sized portable mobile communication terminals having a wired and/or wireless communication function.

However, mobile terminals already have a uniform screen configuration selected by a manufacturer at a time point when consumers buy the mobile terminals.

FIGS. 1A to 1D are diagrams illustrating a uniform screen configuration of the conventional mobile terminal.

FIG. 1A is a diagram illustrating a conventional screen configuration of a universal tablet PC, FIG. 1B is a diagram illustrating a conventional screen configuration specialized for a reader for e-books, FIG. 1C is a diagram illustrating a conventional screen configuration for toddlers and children, and FIG. 1D is a diagram illustrating a conventional screen configuration for teenagers.

FIG. 1A shows a conventional mobile terminal, in which an initial screen provided by a manufacturer is not to be specialized for an age group or a region (or nation) of a consumer. FIG. 1B shows a conventional mobile terminal that is specialized for e-books, which has a screen to help a consumer who is interested in reading e-books. Further, FIG. 1C shows a conventional mobile terminal that provides a user screen specialized for an age group corresponding to a toddler and a child, who is a main consumer of the mobile terminal, and FIG. 1D shows a conventional mobile terminal that provides a user screen specialized for a teenager as a consumer.

Recently, the Information Technology (IT) industry has passed from an age where each family has one computer, to an age where each person has their own computer. Accordingly, mobile terminals that are focused to a usability of a person that uses the mobile terminal with a high mobility have been developed. Since a family intends to use products, such as a smart TV or a tablet PC as family devices in common, there is a need to provide a mobile terminal with a function in which a screen of a common device can change to screens suitable for each member of a family.

However, currently available mobile terminals have uniform screen configurations and a usability selected by a manufacturer thereof Accordingly, each age group has an inconvenience in using products such as a smart TV and a tablet PC, which are used as a family device by a family in common. Further, toddlers and children, for example, may have difficulty in using a mobile terminal without the help of parents. Therefore, mobile terminals suitable for a certain function and an age group have been manufactured. However, there is a problem in that efficiency in use of resources has decreased, because a consumer may buy different products with a similar function, in order to provide devices with appropriate interfaces for different types of consumers and/or age groups.

### SUMMARY OF THE INVENTION

Aspects of the present invention address at least the above-mentioned problems and/or disadvantages and to provide at least the advantages described below.

Accordingly, an aspect of the present invention is to provide an apparatus and method for configuring a screen of a mobile terminal to be suitable for a user.

Another aspect of the present invention is to provide screens suitable for a propensity of various users to one mobile terminal.

In accordance with an aspect of the present invention, a method for configuring a screen of a mobile terminal is provided. The method includes displaying an interface for configuring a screen of the mobile terminal; receiving, through the displayed interface, at least one input for configuring the screen to be suitable for a user; configuring a screen of the mobile terminal corresponding to the received at least one input; and displaying the configured screen.

In accordance with another aspect of the present invention, an apparatus for configuring a screen of a mobile terminal is provided. The apparatus includes a display unit configured to display an interface for configuring a screen of the mobile terminal; and a controller configured to receive, through the displayed interface, at least one input for configuring the screen to be suitable for a user, and to configure a screen of the mobile terminal corresponding to the received at least one input, wherein the display unit displays the configured screen.

In accordance with still another aspect of the present invention, a computer readable storage medium for storing a program including commands for configuring a screen of a mobile terminal is provided. The medium includes a first set of commands for displaying an interface for configuring a screen of the mobile terminal; a second set of command for receiving, through the displayed interface, at least one input for configuring the screen to be suitable for a user; a third set of commands for configuring a screen of the mobile terminal corresponding to the received at least one input; and a fourth set of commands for displaying the configured screen.

### BRIEF DESCRIPTION OF THE DRAWINGS

The above and other aspects, features, and advantages of the present invention will be more apparent from the following detailed description taken in conjunction with the accompanying drawings, in which:

FIG. 1A is a diagram illustrating a conventional screen configuration of a universal tablet PC;

FIG. 1B is a diagram illustrating a conventional screen configuration specialized for a reader for e-books;

FIG. 1C is a diagram illustrating a conventional screen configuration for toddlers and children;

FIG. 1D is a diagram illustrating a conventional screen configuration for teenagers;

FIG. 2 is a schematic block diagram illustrating a mobile terminal according to an embodiment of the present invention;

FIG. 3 is a block diagram illustrating a system for setting a screen of a mobile terminal according to an embodiment of the present invention;

FIG. 4 is a block diagram illustrating an apparatus for setting a screen of a mobile terminal according to an embodiment of the present invention;

FIG. 5 is a view illustrating an example of setting a screen of a mobile terminal according to an embodiment of the present invention;

FIGS. 6A to 6D are views illustrating an example of setting a screen suitable for a nation and a user according to an embodiment of the present invention;

FIG. 7 is a flowchart illustrating a process of setting a screen of a mobile terminal according to an embodiment of the present invention;

FIG. 8A is a view illustrating an example of a screen of a mobile terminal before changing the screen of the mobile terminal; and

FIGS. 8B and 8C are views illustrating an example of changing a screen of a mobile terminal.

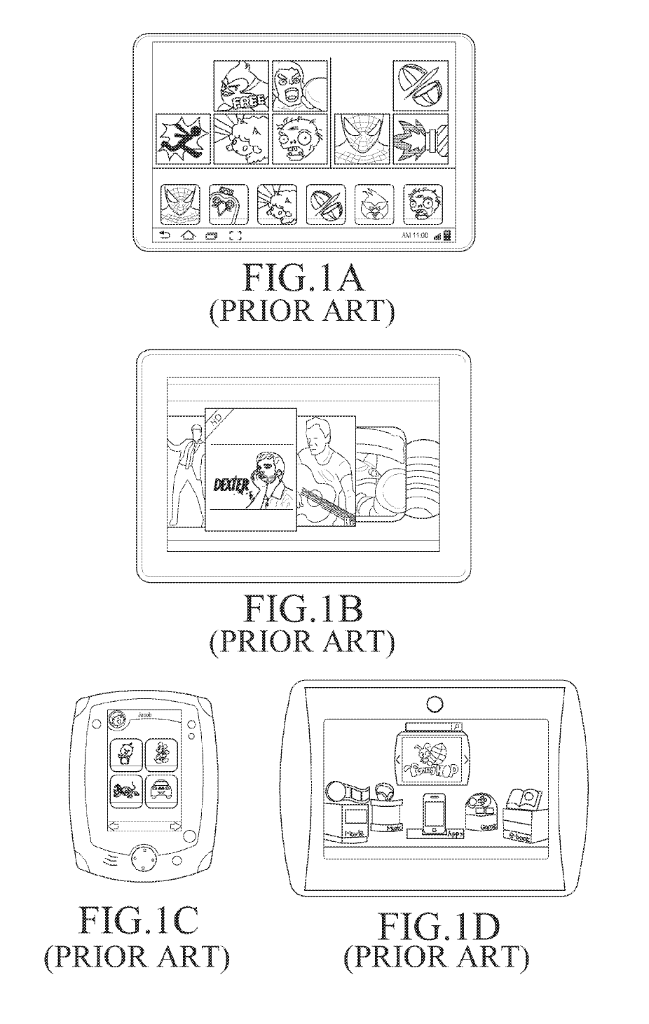

### DETAILED DESCRIPTION OF EMBODIMENTS OF THE PRESENT INVENTION

Hereinafter, embodiments of the present invention are described with reference to the drawings. However, it should be understood that the present invention is not limited to the specific embodiment, but includes all kinds of changes, equivalents, and replacements in the spirit and scope of the present invention.

The terms including ordinal numbers such as first, second, etc. may be used to describe various structural elements. However, the terms do not limit the structural elements, but are only used to distinguish a structural element from another structural element. For example, without departing from the scope of the present invention, a first structural element can be named a second structural element. Similarly, the second structural element can be also named the first structural element. The term “and/or” refers to a combination of related items or any one item of the related items.

The terms used in the description are merely used to describe a specific embodiment, and is not intended to limit the present invention. A singular expression includes a plural expression unless it includes a different meaning in the context. It should be understood that the terms “includes” or “has” in the present application indicate that a feature, numeral, step, operation, structural element, part, or a combinations thereof exists, and do not exclude an additional possibility or existence of one or more other features, numeral, step, operation, structural element, part or combinations thereof.

Unless defined differently, all terms used in the description, which include technical and scientific terminologies, have the same meanings as those generally understood by a person skilled in the art to which the present invention belongs. Terms that are defined in general dictionaries or encyclopedia are interpreted to have meanings identical to those in the context of related technology.

Hereinafter, embodiments of the present invention are described in detail with reference to the accompanying drawings. Further, in the following description, a detailed description of well-known functions and configurations incorporated herein will be omitted when it may make the subject matter of the present invention rather unclear. Further, the terms mentioned below are defined considering functions of the present invention, and may be changed according to a user, an operator's intention, or custom. Therefore, the terms should be defined based on a subject matter throughout the description of the present invention.

As described above, the present invention provides an apparatus and method for setting a screen of a mobile terminal to be suitable for each user. Accordingly, although a family does not buy various products with similar functions, the members of a family can use one mobile terminal in common, thereby efficiently utilizing resources.

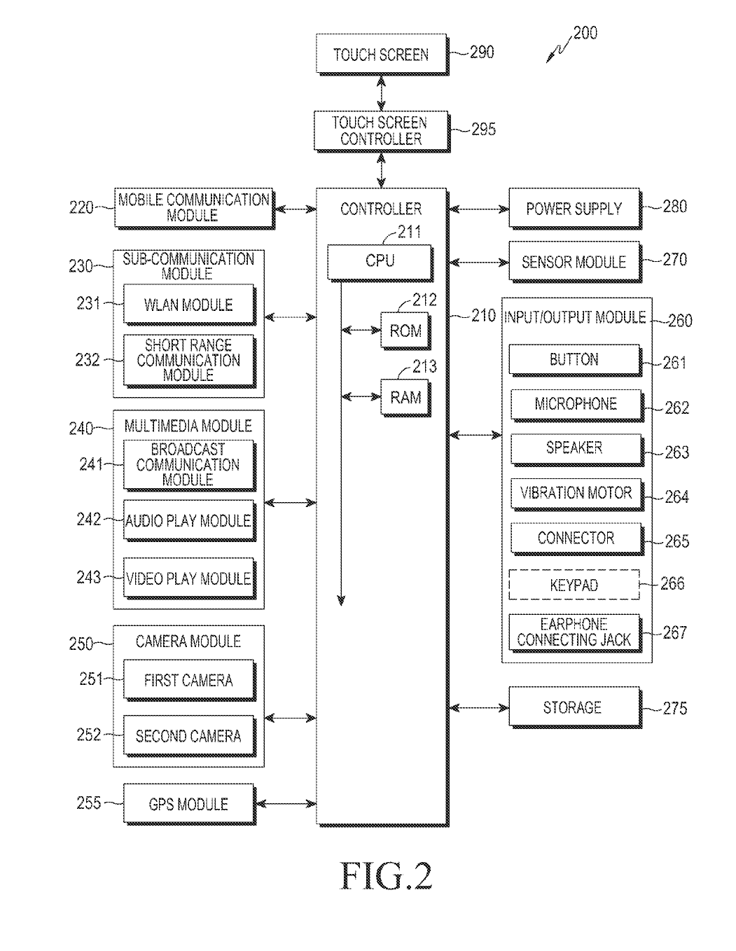

FIG. 2 is a schematic block diagram illustrating a mobile terminal according to an embodiment of the present invention.

As shown in FIG. 2, the mobile terminal 200 is able to connect to an external device (not shown) using an external device connecting unit such as a sub-communication module 230, a connector 265 and an earphone connecting jack 267. The external device may be any of various devices, such as an earphone, an external speaker, an Universal Serial Bus (USB) memory, a charger, a cradle/dock, a mobile payment unit, a health management unit (for example, blood sugar meter), a game player, a navigation unit for a vehicle, and the like, which are detachably connected to the mobile terminal 200 by a wired cable. Further, the external device may include any of a short-range communication unit such as a Bluetooth communication unit, a Near Field Communication (NFC) unit and a Wi-Fi direct communication unit, and a radio Access Point (AP) unit, which are wirelessly connected to the mobile terminal 200 by a short-range communication. Further, the external device may include any of another mobile terminal, a cellular phone, a smart phone, a tablet PC, a desktop PC, and a server.

The mobile terminal 200 may be any of a smart phone, a cellular phone, a game player, a TV, a display unit, a heads-up display unit for a vehicle, a notebook, a laptop computer, a tablet PC, a Personal Media Player (PMP), a Personal Digital Assistant (PDA), etc. Further, the mobile terminal 200 may be a mobile communication terminal having a wireless communication function and a pocket size.

Referring to FIG. 2, the mobile terminal 200 includes a touch screen 290 and a touch screen controller 295. Further, the mobile terminal 200 includes a controller 210, a mobile communication module 220, a sub-communication module 230, a multimedia module 240, a camera module 250, a Global Positioning System (GPS) module 255, an input/output module 260, a sensor module 270, a storage unit 275, and an electric power supplying unit 280. The sub-communication module 230 includes at least one of a wireless Local Area Network (LAN) module 231 and a short-range communication module 232. The multimedia module 240 includes at least one of a broadcasting and communication module 241, an audio reproduction module 242, and a video reproduction module 243. The camera module 250 includes at least one of a first camera module 251 and a second camera module 252, and the input/output module 260 includes at least one of a button 261, a microphone 262, a speaker 263, a vibration motor 264, a connector 265, a keypad 266 and an earphone connecting jack 267.

The controller 210 includes a Central Processing Unit (CPU) 211, a Read-Only Memory (ROM) 212 which stores a control program for controlling the mobile terminal 200, and a Random Access Memory (RAM) 213, which stores signals or data input from the outside of the mobile terminal 200 or is used as a memory region for an operation which is carried out in the mobile terminal 200. The CPU 211 may include a single-core CPU or a multi-core CPU (e.g., a dual-core CPU, a triple-core CPU, a quad-core CPU, etc.). The CPU 211, the ROM 212 and the RAM 213 can be connected to one another through an internal bus.

The controller 210 controls the mobile communication module 220, the sub-communication module 230, the multimedia module 240, the camera module 250, the GPS module 255, the input/output module 260, the sensor module 270, the storage unit 275, the electric power supplying unit 280, the touch screen 290, and the touch screen controller 295.

A combination of mobile communication module 220, the sub-communication module 230, and the broadcasting communication module 241 of the multimedia module 240 may be referred to as a communication unit. The communication unit is provided for a direct connection or a connection with the external device through network, and may be a wired and/or wireless communication unit. The communication unit transmits data from the controller 210, the storage unit 275, the camera module 250, etc. to the external device by wired cable or wirelessly, and/or receives data from an external communication line or atmosphere by wired cable or wirelessly so as to transmit and/or store the data to the controller 210 and/or the storage unit 275.

The mobile communication module 220 enables the mobile terminal 200 to connect to the external device through the mobile communication using at least one antenna (not shown), under a control of the controller 210. The mobile communication module 220 transmits and receives radio signals for exchange, one-way transmission, one-way reception of data such as a voice call, a video call, a Short Message Service (SMS), a Multi-Media Service (MMS) with, to, or from a smart phone (not shown), a tablet PC, or another device (not shown) which has a phone number stored in the mobile terminal 200, or a network address.

The sub-communication module 230 may include at least one of the wireless LAN 231 and the short-range communication module 232. For example, the sub-communication module 230 may include either one or both of the wireless LAN module 231 and the short-range communication module 232.

The wireless LAN module 231 is connected to the Internet at a place where a radio AP (not shown) is equipped, under a control of the controller 210. The wireless LAN module 231 supports the provision for the wireless LAN, i.e., IEEE802.11x, of the Institute of Electrical and Electronics Engineers (IEEE). The short-range communication module 232 can carry out a short-range wireless communication between the mobile terminal 200 and an image forming device (not shown), under a control of the controller 210. The short-range communication scheme may include a Bluetooth communication scheme, an InfraRed Data Association (IrDA) communication scheme, a Wi-Fi direct communication scheme, an NFC scheme, etc.

The multimedia module 240 includes the broadcasting and communication module 241, the audio reproduction module 242, and/or the video reproduction module 243. The broadcasting and communication module 241 receives broadcasting signals, for example TV broadcasting signals, radio broadcasting signals, data broadcasting signals, and broadcasting additional information, for example Electric Program Service (EPS) and Electric Service Guide (ESG), which are transmitted from a broadcasting station through a broadcasting and communication antenna (not shown), under a control of the controller 210. The audio reproduction module 242 reproduces a digital audio file, such as a file having an extension name of mp3, wma, ogg, way, etc., which is stored in the mobile terminal 200, or received, through a speaker 263, under a control of the controller 210. The video reproduction module 243 reproduces a digital video file, such as a file having an extension name of mpeg, mpg, mp4, avi, mov, mkv, etc., which is stored or received, through the touch screen 290, under a control of the controller 210.

The multimedia module 240 may include the audio reproduction module 242 and the video reproduction module 243, without including the broadcasting and communication module 241. Further, the audio reproduction module 242 and/or the video reproduction module 243 of the multimedia module 240 may be included in the controller 210.

The camera module 250 includes at least one of a first camera 251 and a second camera 252 for photographing a stationary image or a video under a control of the controller 210. Further, the first camera 251 or the second camera 252 may include an auxiliary light source (not shown), such as a flash, which supplies an amount of light necessary for photography. The first camera 251 may be disposed on a front surface of the mobile terminal 200 while the second camera 252 is disposed on a rear surface of the mobile terminal 200. As an alternative, the first and second cameras 251 and 252 may be arranged to be adjacent to each other, for example at a distance in a range of 1 cm to 8 cm, so as to photograph a three-dimensional stationary image or a three-dimensional video.

The first and second cameras 251 and 252 may respectively include a lens system, an image sensor, a flash, etc. The first and second cameras 251 and 252 can respectively convert optical signals which are input or taken through the lens system, into electrical image signals, and in turn output the image signals to the controller 210. A user can take a video or a stationary image through the first and second cameras 251 and 252.

The lens system collects light incident from the exterior to form an image of a subject. The lens system includes one or more lenses, each of which may be a convex lens, an aspheric lens, etc. The lens system has symmetry around an optical axis passing through a center thereof The optical axis is defined as a center axis. The image sensor converts an optical image that is formed by outside light incident through the lens system, into an electric image signal. The image sensor includes a plurality of pixel units arranged in a matrix of M×N. The pixel units include a photodiode and a plurality of transistors. The pixel units accumulate electric charges generated by the incidence light, and a voltage of the accumulated electric charges indicates an illuminance of the incidence light. When a stationary image or an image for forming a video is processed, the image signal output from the image sensor is constituted by a collection of voltages output from the pixel units, i.e., pixel values, and the image signal indicates one frame, i.e., a stationary image. Further, the frame is formed by M×N pixels. A Charge-Coupled Device (CCD) image sensor, a Complementary Metal-Oxide Semiconductor (CMOS) image sensor, etc. may be used as the image sensor.

A driving unit drives the image sensor under a control of the controller 210. The driving unit drives at least some pixels of a region of interest among all of the pixels of the region in response to a control signal received from the controller 210, and outputs image data, which are output from the pixels, to the controller 210.

The controller 210 processes an image input from each of the first and second cameras 251 and 252 or an image stored in the storage unit 275 frame by frame, and outputs image frames, which are converted to be suitable for a screen feature, i.e., a size, an image quality, a resolution, etc., of the touch screen 290, to the touch screen 290.

The GPS module 255 receives electric waves from a plurality of GPS satellites in the Earth's orbit.

The input/output module 260 includes at least one of a plurality of buttons 261, a microphone 262, a speaker 263, a vibration motor 264, a connector 265, a keypad 266 and an earphone connecting jack 267. The input/output module 260, except for the connector 265, can be used as a means for receiving a user's input or notifying a user of information, and includes a mouse, a trackball, a joystick, and a cursor controller such as cursor direction keys, as other examples. However, the input/output module 260 is not limited to those examples.

The buttons 261 may be arranged on a front surface 200a, a side surface 200b, and/or a rear surface 200c of the mobile terminal 200, and include at least one of an electric power button 261d, a volume control button 261e having a volume increasing button 261f and a volume decreasing button 261g, a menu button 261d, a home button 261a, a back button 261c, and a searching button.

The microphone 262 receives voices or sounds from a user or a surrounding environment to generate electric signals under a control of the controller 210.

The speaker 263 outputs sounds corresponding to various signals, for example radio signals, broadcasting signals, digital audio files, digital video files, photographing, etc., which are generated from the mobile communication module 220, the sub-communication module 230, the multimedia module 240, or the camera module, to the exterior of the mobile terminal 200. The speaker 263 outputs sounds, such as a button operation sound corresponding to a phone call, or a ringtone, corresponding to functions that the mobile terminal 200 performs, under a control of the controller 210. One or more speakers 263 may be arranged at suitable positions of the mobile terminal 200.

The vibration motor 264 can convert electric signals into mechanical signals under a control of the controller 210. For example, when the mobile terminal 200 operates in a vibration mode, the mobile terminal 200 operates the vibration motor when receiving a voice call or a video call from another device (not shown). One or more vibration motors may be arranged in the mobile terminal 200. The vibration motor may be operated in response to a touch of a user who touches the touch screen 290, or continuous movements of the touches on the touch screen 290.

The connector 265 is as an interface for connecting the mobile terminal 200 with the external device (not shown) or with an electric power source (not shown). The mobile terminal 200 may transmit data, which is stored in the storage unit 275 of the mobile terminal 200, to the external device (not shown) through a wired cable connected to the connector 265, or receive data from the external device. The mobile terminal 200 may be supplied with electric power by the electric power source (not shown) through the wired cable connected to the connector 265, or a battery of the mobile terminal can be charged by using the electric power source.

The keypad 266 receives key input of a user to control the mobile terminal 200. The keypad 266 may include a physical keypad (not shown) arranged on the mobile terminal 200 and/or a virtual keypad (not shown) displayed on the touch screen 290. The physical keypad (not shown) arranged on the mobile terminal 200 may be excluded according to the performance or the structure of the mobile terminal 200. An earphone (not shown) is inserted in the earphone connecting jack 267 and connected to the mobile terminal 200.

The sensor module 270 includes at least one sensor for detecting a status, such as a location, a direction, a movement, etc., of the mobile terminal 200. For example, the sensor module 270 may include a proximity sensor (not shown) for detecting whether a user comes close to the mobile terminal 200, an illuminance sensor (not shown) for detecting an amount of light near the mobile terminal 200, a motion/direction sensor (not shown) for detecting an operation, i.e., a rotation, an acceleration, a retardation, a vibration, etc., of the mobile terminal 200, or an altimeter (not shown) for measuring an atmospheric pressure to detect an altitude. Further, the motion/direction sensor may include an acceleration sensor (not shown), a geo-magnetic sensor (not shown) for detecting a point of a compass using the magnetic field of the Earth, a gravity sensor (not shown) for detecting an operation direction of the gravity, a gyro sensor (not shown), a shock sensor (not shown), a compass sensor (not shown), and/or an acceleration sensor (not shown). The sensor module 270 detects the status of the mobile terminal 200, generates signals corresponding to the detection so as to transmit the signals to the controller 210. The sensors of the sensor module 270 may be added or removed according to the functions performed by the mobile terminal 200.

The storage unit 275 can store signals or data which are input in/output from the mobile communication module 220, the sub-communication module 230, the multimedia module 240, the camera module 250, the GPS module 255, the input/output module 260, the sensor module 270, or the touch screen 290, under a control of the controller 210.

The term “storage unit” refers to the storage unit 275, the ROM 212 and the RAM 213 in the controller 210, or a memory card, i.e., a Secure Digital (SD) card, a memory stick, etc., detachably inserted in the mobile terminal 200.

The storage unit 275 can store images for providing a Graphical User Interface (GUI) relating to various applications such as a navigation application, a video call application, a game application, and an alarm application based on time, data bases or data relating to a method for processing user information, documents, and touch inputs, background images, i.e., menu screens, standby screens, etc., or operating programs necessary for the operation of the mobile terminal, and images taken by the camera module 250. The storage unit 275 may be a medium that a machine, i.e., a computer, can read. The term “a medium which a machine can read” can be defined as a medium that provides data to the machine so that the machine performs a certain function. The machine-readable medium may be a storage medium. The storage unit 275 may include non-volatile media and volatile media. Herein, media refers to a type of media for which commands can be detected by a physical instrument that can read the commands for the machine

The machine-readable media include at least one of a floppy disk, a flexible disk, a hard disk, a magnetic tape, a Compact Disc (CD)-ROM, an optical disk, a punched-card, a paper tape, a RAM, a Programmable ROM (PROM), an Erasable PROM (EPROM), and a flash-EPROM, but embodiments of the present invention are not limited thereto.

The electric power supply unit 280 supplies electric power to at least one battery arranged in the mobile terminal 200, under a control of the controller 210. The batteries (not shown) supply electric power to the mobile terminal 200. Further, the electric power supply unit 280 can supply the mobile terminal 200 with electric power input from an external electric power supply source (not shown) through a wired cable connected to the connector 265. Further, the electric power supply unit 280 may supply the mobile terminal 200 with electric power wirelessly input from the external electric power source by using a wireless charging technology.

The touch screen 290 displays data input from the controller 210 to a user, and provides the GUI corresponding to various services, i.e., a call, a data transmission, broadcasting, photography, etc., to the user. The touch screen 290 transmits analog signals corresponding to at least one touch input or hovering inputs for the GUI to the touch screen controller 295. The touch screen 290 receives at least one input through a user input means, i.e., a finger, a pen, etc. Further, the touch screen 290 may receive a continuous movement of a touch, i.e., a drag, flick, swipe, etc.

In addition, according to embodiments of the present invention, the touch screen input is not limited to the touch screen 290 and the user input means, i.e., a finger, a pen, and the like, and may include a non-contact input, which is held at short distance, such as a distance less than 1 cm, for example, between the touch screen 290 and the user input means. An input recognition distance in the touch screen 290 may be changed according to the functions performed by or structure of the mobile terminal 200. In particular, the touch screen 290 and/or the pen are configured so that the output value thereof can be changed according to the distance (or contact and non-contact) between the user input means and the touch screen, thereby distinctively detecting a touch event caused by contact with the user input means, and an input event, i.e., hovering, in the non-contact condition. The touch screen 290 is configured to differently output a value, i.e., a value of electric current, voltage, resistance, electrostatic capacity, etc., detected by the touch event and a value detected by the hovering event.

The touch screen controller 295 converts analog signals that are received from the touch screen 290, into digital signals, i.e., X and Y coordinates, and an intensity value of an input (or detected value), and transmits the digital signals to the controller 210. The controller 210 controls the touch screen 290 by using the digital signals received from the touch screen controller 295. For example, the controller 210 enables a short-cut icon displayed on the touch screen 290 (or an application) to be selected or executed in response to the touch event or the hovering event. Further, the touch screen controller 295 may be included the controller 210 or the touch screen 290.

The touch screen controller 295 calculates a distance between the user input means and the touch screen 290, depending on the value output from the touch screen 290, and converts the calculated distance into the digital signals, i.e., a Z coordinate, to provide the digital signals to the controller 210.

The touch screen controller 295 determines whether the user input means comes in contact with or provides a non-contact input with respect to the touch screen 290, depending on the value output from the touch screen 290, and converts a value that indicates the determined contact or non-contact into digital signals to provide the digital signals to the controller 210.

The touch screen 290 may include two or more touch screen panels for respectively sensing a finger input and a pen input, so as to distinctively detect an input, i.e., a finger input, by means of an inactive type of a first user input means, and an input, i.e., a pen input, by means of an active type of a second user input means. With respect to the user input means, detection of the distinction between the inactive type and the active type is achieved according to whether energy such as an electric wave, an electromagnetic wave, etc., is generated or induced to be output. At least two touch screen panels respectively provide a different output value to the touch screen controller 295, and the touch screen controller 295 recognizes the different values, which are input from the at least two touch screen panels, so as to distinguish the input by means of the finger from the input by means of the pen, which are received from the touch screen 290. For example, the touch screen 290 may have a structure in which a capacitive type of a touch screen panel and an electromagnetic resonance type of a touch screen panel are combined. Further, as described above, since the touch screen 290 is configured to have the touch keys such as the menu button 261b, the back button 261c, and the like, the finger input in the present invention or the finger input on the touch screen 290 includes a touch input on the touch keys. Hereinafter, an apparatus and method for changing a customized-screen for a user in the mobile terminal is described.

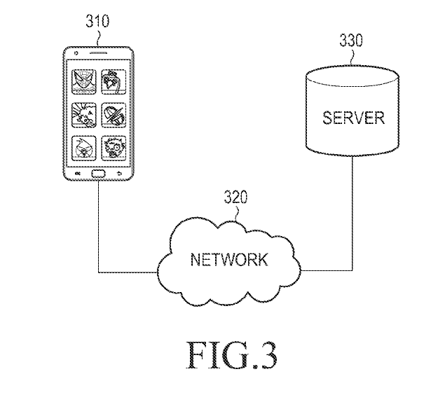

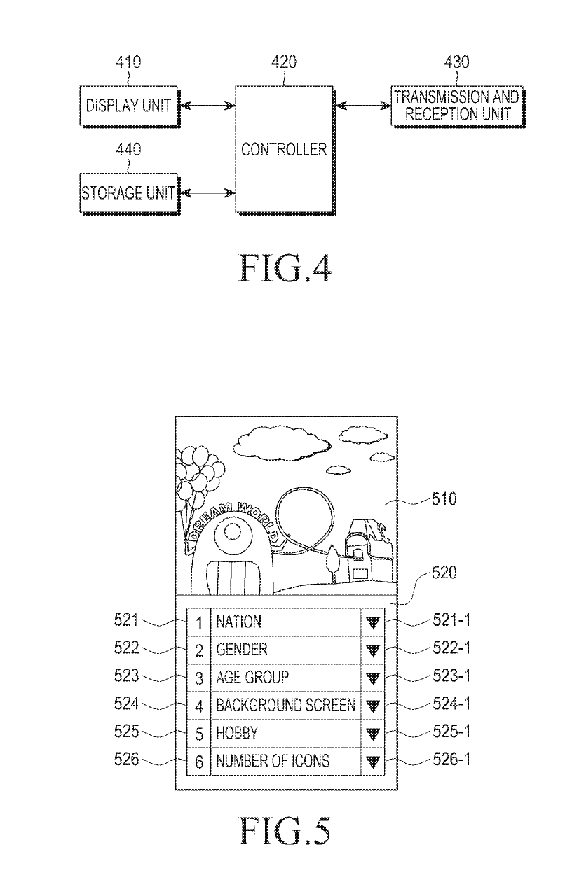

FIG. 3 is a block diagram illustrating a system for changing a screen of a mobile terminal according to an embodiment of the present invention, and FIG. 4 is a block diagram illustrating an apparatus for changing a screen of a mobile terminal according to an embodiment of the present invention.

Referring to FIGS. 3 and 4, the system for changing the screen of the mobile terminal according to an embodiment of the present invention includes a mobile terminal 310 in which a screen is intended to be changed, a server 330 for transmitting information on a setting of the screen to the mobile terminal 310, and a network 320 for providing information or data transmission and reception between the mobile terminal 310 and the server 330. Referring to FIG. 4, the mobile terminal includes a display unit 410 for displaying a screen to a user, a storage unit 440 for storing a screen setting module or application that receives a command for changing the screen of the mobile terminal such as a basic background screen for each age, a plurality of content icons, a basic background screen for each nation, a personal favorite background screen, from a user, a controller 420 for determining whether a screen setting to be input is identical to stored screen information, and a transceiver unit 430 for transmitting at least one of the basic background screen, the icons, the set screen, and a content corresponding to the set screen, which are provided to the user, to the server 330 through the network 320 and receiving data from the server 330, when the at least one of the basic background screen, the icons, the set screen, and the content are not stored in the storage unit.

FIG. 4 illustrates an apparatus for changing the screen of the mobile terminal according to an embodiment of the present invention, but it is simply shown for the convenience of the description. The elements of the mobile terminal shown in FIG. 4 can perform functions performed by the corresponding elements of the device of FIG. 2.

For example, the transceiver 430 of FIG. 4 may include the mobile communication module 220, the sub-communication module 230, and the GPS module 255 of FIG. 2, and also may include a module for transmitting and receiving data through various communication protocols such as Internet, Wireless Broadband (WiBro), Wi-Fi, as well as various modules for carrying out communication with peripheral devices of the mobile terminal through a cable.

Further, the storage unit 440 can store images for providing a Graphical User Interface (GUI) relating to various applications such as a navigation application, a video call application and a game application, databases or data relating to a method for processing user information, documents, and touch inputs, and background images or operating programs necessary for the operation of the mobile terminal. The storage unit 440 may store a basic background screen for each nation, a favorite background screen, a user's age, a gender, a favorite content, and a plurality of contents, information setting modules or applications for configuring a screen suitable for a user's needs and nation.

Furthermore, the display unit 410 may include a touch screen for displaying data for a user, providing a GUI corresponding to various services, i.e., a voice call, a data transmission, broadcasting, and photographing, to the user, and receiving at least one touch input for the GUI or analog signals corresponding to a hovering input. The user can set or change a screen of the mobile terminal suitable to his/her taste through the display unit 410. Moreover, the display unit 410 may display a popup for notifying a user of the absence or presence of a video conference call and that data transmitted to and received from another mobile terminal are currently shared with a plurality of users, and data transmitted from a device for a video conference call, or receive an input of a user's response to the absence or the presence of the video conference call.

The display unit 410 also displays a setting screen for receiving an input for setting a screen of the mobile terminal under a control of the controller 420, and also displays stored screen information and at least one content when a screen setting input by the user is identical to the stored screen information. Further, when information corresponding to the screen setting according to the user's needs is received from the server 330, the display unit 410 displays the received information and the at least one content. Such a setting screen is provided to receive at least one selection or input of a user for editing the screen of the mobile terminal. The setting screen is provided to receive an input for setting a configuration, an arrangement, or a design to be suitable for a desire, a hobby, a taste, an age, or a personality of the user.

Moreover, the display unit 410 may receive a selection or an input of a user for at least one of a basic background screen for each nation, a favorite background screen, a user's age, a gender, a favorite content and the number of the contents.

The controller 420 controls or generates at least one of a series of channel connections for a video conference call, a data transmission and reception, and a vibration, a sound and a pop-up window for indicating the data transmission and reception, and controls a connection with a device for providing a multipoint communication. Further, the controller 420 controls a display of a setting screen for receiving an input of changing a screen of the mobile terminal to be suitable for a user's desire, and determines whether the screen setting to be input thereafter is identical to the stored screen information. If the screen setting is identical to the stored screen information, the controller 420 extracts and displays the stored information corresponding to the screen setting, and the contents from the storage unit. However, if the screen setting is not identical to the stored screen information, the controller 420 requests the server to transmit information corresponding to the screen setting to the mobile terminal. The stored information may include a plurality of icons or contents for each of a nation, a background screen, a user's age, and a gender.

Moreover, the controller 420 determines whether the screen setting input through the display unit 410 is identical to the stored screen information. If the screen setting is not identical to the stored screen information, the controller 410 extracts the stored information corresponding to the screen setting from the storage unit 440. Further, if the screen setting is not identical to the stored screen information, the controller 420 requests the server 330 to transmit the information corresponding to the screen setting and the contents corresponding to the information through the network 320.

Moreover, the controller 420 receives, through the displayed interface, at least one input for configuring the screen to be suitable for a user, and configures a screen of the mobile terminal corresponding to the received at least one input, wherein the display unit displays the configured screen. The controller 420 reads, upon determining that the received input for configuring the screen is not identical to previously-stored screen information, contents corresponding to the screen information stored by the storage unit, and configures the screen by using the read contents. The controller 420 requests, from a server, upon determining that the received input for configuring the screen is not identical to the previously-stored screen information, contents corresponding to the screen information, receives the requested content corresponding to the screen information from the server, and configures the screen by using the received content corresponding to the screen information. The interface receives at least one selection or input for editing the screen from the user, and further receives an input for setting a structure, an arrangement, or a design of the screen to be suitable for a desire, a hobby, a taste, an age, and a personality of the user.

FIG. 5 is a diagram illustrating an example of setting a screen of a mobile terminal according to an embodiment of the present invention.

Referring to FIG. 5, an embodiment of the present invention provides individualized user screens suitable for tastes of each of a plurality of users in one mobile terminal. By setting at least one of a nation, a gender, a user's age, a background screen, a hobby, and the number of icons as a screen suitable for a user's tastes in a screen setting mode of the mobile terminal, it is possible for a user to decorate the touch screen with a user's desired screen. The screen setting mode may be distinguished into a background screen 510 that is basically provided or is changeable by a user, and a selection window 520 in which a plurality of items for a screen setting is listed. The selection window 520 may be configured to have a plurality of items, each of which may be selected by the user according to the user's taste or propensity. Each item has a plurality of lists. For example, in a nation selection item 521, when the user intends to decorate a screen with a corresponding nation type, the user clicks the selection window 521-1 and selects a desired nation from a list of nations, (e.g. Korea, the United States, Japan, France, etc.). Likewise, a gender item 522 is provided to configure a screen according to a user's gender. The age selection item 523 is classified into groups such as toddler, child, elementary school, middle school, high school, and adult, or into age groups such as 3˜5 years, 6˜7 years, 8˜13 years, 13˜19 years and more than 20 years. A background selection item 524 is provided to configure a background screen to be suitable for a user's taste, and a hobby selection item 525 is provided to configure a screen to be suitable for a user's hobby such as fishing, travel, reading, and watching a movie. An item 526 for selecting the number of icons is provided to configure the number of icons to be displayed on the display unit.

The selectable items described above are merely provided as examples, and different amounts of items may be included according to a user's personality. Moreover, the items may be set in advance, or changed, deleted, added, and created by the user. The plurality of icons, skins, and screens, which respectively correspond to the respective items (i.e., nation, gender, age group, background screen, hobby, or number of icons), can be stored in advance, or downloaded and stored by the user. Otherwise, the contents may correspond to the downloaded contents that are edited and stored to be suitable for the user.

As described above, the screen is configured through selection of the plurality of items and desired contents among the plural contents corresponding to the selected temporary item in order to provide a user screen that is different for each nation, each person, each taste, and each age group. Hereinafter, a result of setting a screen to be suitable for each nation and each user is described.

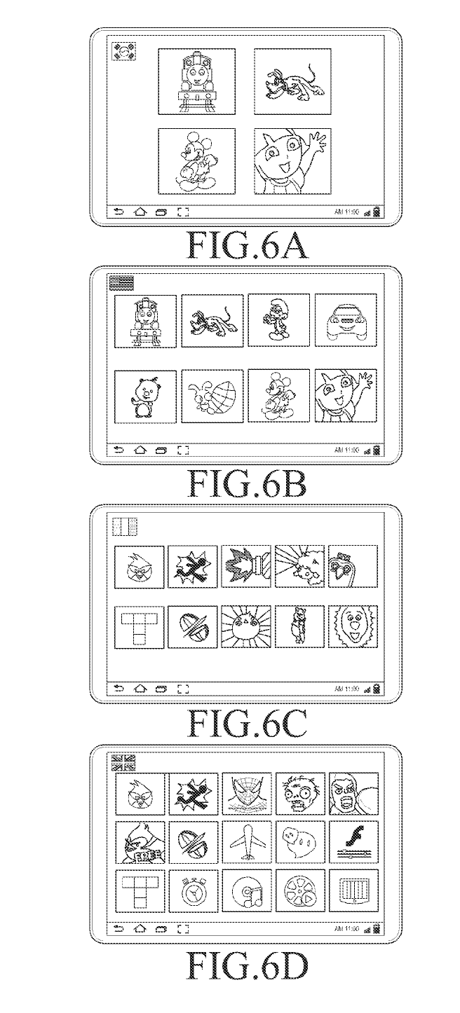

FIGS. 6A to 6D are diagrams illustrating an example of displaying a screen suitable for a nation and a user according to an embodiment of the present invention.

FIG. 6A shows an example of selecting Korea in the nation selection item 521, and an age group of 3˜5 years in the age group selection item 523, from among the plurality of items for configuring a screen. FIG. 6B shows an example of selecting the United States in the nation selection item 521, and an age group of 6˜7 years in the age group selection item 523, from among the plurality of items for configuring a screen. FIG. 6C shows an example of selecting France in the nation selection item 521, and an age group of 8˜19 years in the age group selection item 523, from among the plurality of items for configuring a screen. FIG. 6D shows an example of selecting the United Kingdom in the nation selection item 521, and an age group of more than 20 years in the age group selection item 523, from among the plurality of items for configuring a screen.

Referring to FIGS. 6A to 6D, each nation has representative structures, cultures, and relics. When the nation is selected, background screens corresponding to the selected nation are provided. For example, in Korea, the symbols of the nation are Gyeongbokgung, Arirang, Bulguksa, etc., and a screen showing these symbols is configured to be a background screen. A number of icons are configured to correspond to each age group. By selecting a corresponding age group, icons or contents to be configured to be suitable for the corresponding age group are displayed on the displayed unit. The number of the icons corresponding to each age group to be displayed is configured differently, since each age group has different recognition ability. By configuring the screen to be provided differently for each age group, an improved user environment is provided. In FIGS. 6A to 6D, the numbers of icons according to each age group are shown. However, the screens of FIGS. 6A to 6D area merely provided as examples, and even though the numbers of icons to be displayed are selected from the item 526 for selecting the numbers of icons, the selected numbers of the icons may be displayed as shown in FIGS. 6A to 6D.

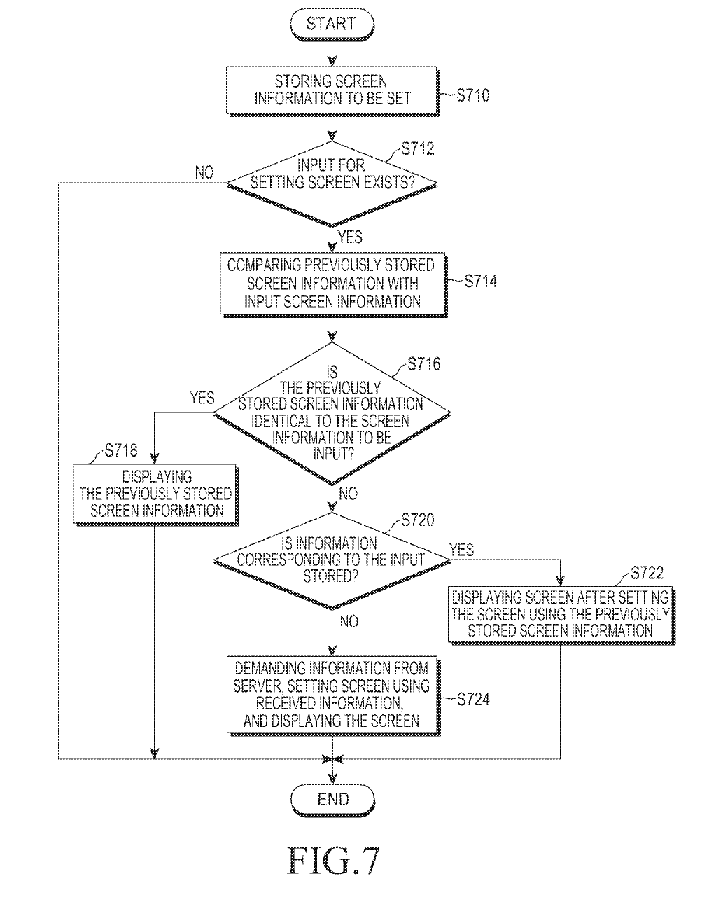

FIG. 7 is a flowchart illustrating a process of changing a screen of a mobile terminal according to an embodiment of the present invention.

Referring to FIG. 7, in step S710, a set screen is displayed in order to receive an input for setting a screen from a user, and information on the screen to be set by the input for setting the screen through the displayed setting screen is stored. The setting screen is provided to receive an input of a user relating to at least one selection or command for editing the screen. More specifically, the user selects at least one desired, hobby, taste, age, nation, gender, background screen, personality, and the number of icons to be displayed, and in turn configures a structure, an arrangement, or a design of the screen.

Then, in steps S712 and S714, when an input for configuring a screen exists or is completed, screen information generated by the completed input is compared with the stored screen information. The controller compares the screen information generated by the completed input with set screen information at an initial setting of the mobile terminal or screen information before the input for setting the screen is input. The stored existing screen information has a plurality of icons, skins, screens, contents, etc., and is either previously stored in the storage unit of the mobile terminal or may be downloaded and stored by the user.

If the stored existing screen information is identical to the input screen information in step S716, the controller displays the stored existing screen information on the display unit in step S718. As described above, if the stored existing screen information is identical to the input screen information, an identical screen setting has been established and stored, achieved and stored by a user, or performed by a manufacturer of the mobile terminal.

If the stored screen information is not identical to the input screen information in step S716, the controller checks whether the information for setting the screen input in step S712 is stored in the storage unit, in steps S716 and S720. More specifically, if the screen setting is not identical to the stored screen information, the controller checks whether contents corresponding to the respective input items among the plurality of items that correspond to the screen setting are stored in the storage unit.

If the information for setting the screen by an input is stored in the storage unit in step S720, the controller performs a screen setting process of fusing contents in order to display the screen by using the stored information, and in turn, displays the screen on the display unit in step S722. More specifically, some items among the plurality of selected items correspond to a case where although the contents are previously stored, a corresponding item has not been previously selected and set up in the screen information. In this case, items that are not selected are listed in the screen information, and contents corresponding to all the selected items that are listed are fused and in turn displayed on the display unit.

If the screen setting information by the input is not stored in the storage unit in step S720, the controller requests a server to transmit the contents that are not already stored in the storage unit, and sets a screen by using the contents received from the server, before displaying the screen in step S724. More specifically, if the screen setting is not identical to the stored screen information and has not been previously stored, the controller demands information corresponding to the screen setting from the server and applies corresponding contents to the screen setting that is received from the server before the screen setting is displayed.

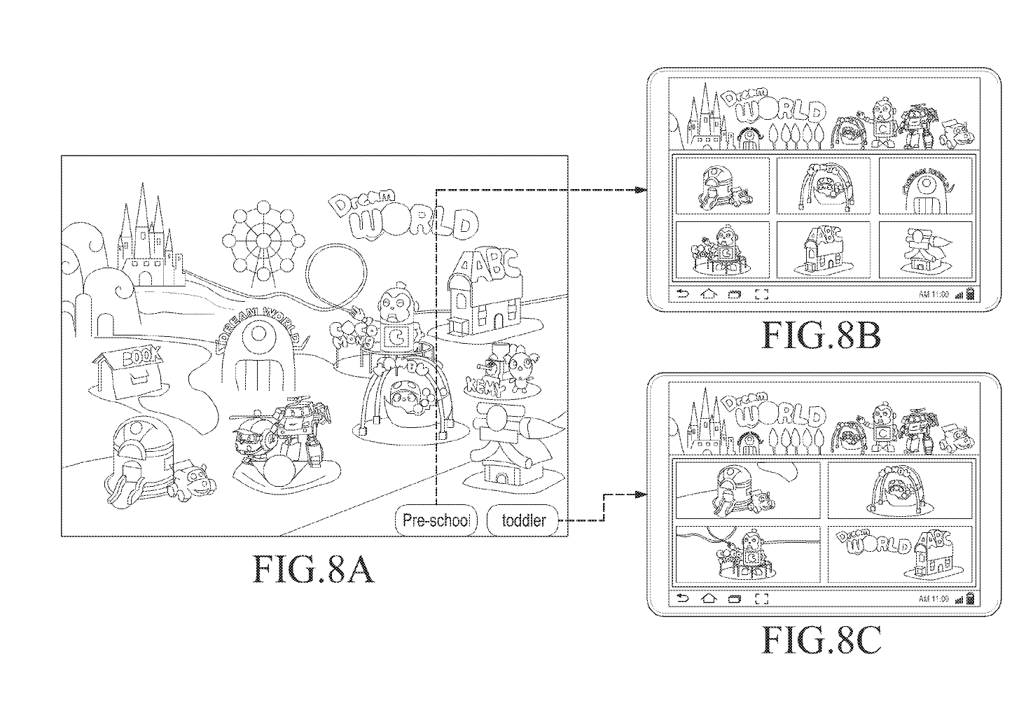

FIGS. 8A to 8C are diagrams illustrating an example of applying a change of a screen setting of the mobile terminal according to an embodiment of the present invention.

FIG. 8A is a view illustrating an example of a screen of a mobile terminal before changing the screen of the mobile terminal, and FIGS. 8B and 8C are views illustrating an example of changing a screen of a mobile terminal.

Referring to FIGS. 8A to 8C, a screen displayed on the display unit can be set to according to a user's taste, according to age group such as toddler, child, juvenile, or adult. For example, a screen suitable for a toddler can be set. In a case of a juvenile, a screen that helps the juvenile study can be set. In a case of an adult, a screen can be set according to the adult's hobby or personality. When the screen of the mobile terminal is set through the above-mentioned process, an initial screen, as shown in FIG. 8A, is changed to any of various screens that are set for each corresponding age group, and the various screens can be displayed. For example, when a user of the mobile terminal belongs to an age group of a toddler of 3˜7 years, the screen is changed to a screen suitable for the age group of the toddler, as shown in FIG. 8C. When a user belongs to an age group of a child of 8˜13 years, the screen of the mobile terminal is changed to a screen suitable for a child of 8˜13 years as shown in FIG. 8B.

Embodiments of the present invention may be implemented in the form of hardware, software, or a combination thereof Any such software may be stored in a volatile or non-volatile storage device such as a Read-Only Memory (ROM), or in a memory such as a Random Access Memory (RAM), a memory chip, a memory device or a memory integrated circuit, or in a storage medium, such as a Compact Disc (CD), a Digital Versatile Disc (DVD), a magnetic disk or a magnetic tape that is optically or magnetically recordable and simultaneously, is readable by a machine (e.g., a computer), regardless of whether the software can be deleted or rewritten. The above-described storage devices and storage media are merely example of machine-readable storage that are suitable for storing a program or programs comprising instructions that, when executed, implement exemplary embodiments of the present invention. Accordingly, embodiments of the present invention may include a program having code for implementing apparatus or a method as claimed in any one of the claims of this specification and a machine-readable storage storing such a program.

Further, a mobile terminal according to embodiments of the present invention can receive and store the programs from a program-providing device that is connected thereto by a wired-cable or wirelessly. The program-providing device includes a program including codes for implementing a method of setting a screen of the mobile terminal, a memory or a storage unit for storing information necessary for a performance of the method of setting the screen of the mobile terminal, a communication unit for performing a wired or wireless communication with the mobile terminal, and a controller for transmitting a corresponding program to the host device automatically or in respond to a demand of the mobile terminal.

While the present invention has been shown and described with reference to certain embodiments thereof, it will be understood by those skilled in the art that various changes in form and details may be made therein without departing from the spirit and scope of the present invention as defined by the appended claims and their equivalents.

What is claimed is:

1. A method for configuring a screen of a mobile terminal, the method comprising:
displaying an interface for configuring a screen of the mobile terminal;
receiving, through the displayed interface, at least one input for configuring the screen to be suitable for a user;
configuring a screen of the mobile terminal corresponding to the received at least one input; and
displaying the configured screen.

2. The method as claimed in claim 1, further comprising:
storing screen information set by the input for configuring the screen,
wherein the screen information is generated by the received at least one input.

3. The method as claimed in claim 2, further comprising:
reading, upon determining that the received input for configuring the screen is not identical to previously-stored screen information, contents corresponding to the screen information stored by a storage unit; and
configuring the screen by using the read contents.

4. The method as claimed in claim 3, wherein the previously-stored information includes a plurality of icons or contents for each nation, each background screen, each age group of a user, and each gender.

5. The method as claimed in claim 2, further comprising:
requesting, from a server, upon determining that the received input for configuring the screen is not identical to the previously-stored screen information, contents corresponding to the screen information;
receiving the requested content corresponding to the screen information from the server; and
configuring the screen by using the received content corresponding to the screen information.

6. The method as claimed in claim 5, wherein the interface receives at least one selection or command for editing the screen from the user.

7. The method as claimed in claim 5, wherein the interface further receives an input for setting a structure, an arrangement, or a design of the screen to be suitable for at least one of a desire, a hobby, a taste, an age, and a personality of the user.

8. The method as claimed in claim 7, wherein the interface receives a selection or an input for at least one of a basic background screen for each a plurality of nations, a favorite background screen, an age group of a user, a gender, favorite contents, and numbers of the contents, through the displayed interface.

9. The method as claimed in claim 1, wherein the displayed screen comprises at least one content corresponding to the received at least one input, and the at least one content is suitable for at least one of a desire, a hobby, a taste, an age and a personality of the user.

10. The method as claimed in claim 1, wherein the interface includes at least one of a basic background screen for each nation, a favorite background screen, an age group of a user, a gender, favorite contents, and numbers of the contents.

11. An apparatus for configuring a screen of a mobile terminal, the apparatus comprising:
a display unit configured to display an interface for configuring a screen of the mobile terminal; and
a controller configured to receive, through the displayed interface, at least one input for configuring the screen to be suitable for a user, and to configure a screen of the mobile terminal corresponding to the received at least one input,
wherein the display unit displays the configured screen.

12. The apparatus as claimed in claim 11, further comprising:
a store unit configured to store screen information set by the input for configuring the screen,
wherein the screen information is generated by the received at least one input.

13. The apparatus as claimed in claim 12, wherein the controller reads, upon determining that the received input for configuring the screen is not identical to previously-stored screen information, contents corresponding to the screen information stored by the storage unit, and configures the screen by using the read contents.

14. The apparatus as claimed in claim 13, wherein the previously- stored information includes a plurality of icons or contents for each nation, each background screen, each age group of a user, and each gender.

15. The apparatus as claimed in claim 12, wherein the controller requests, from a server, upon determining that the received input for configuring the screen is not identical to the previously-stored screen information, contents corresponding to the screen information, receives the requested content corresponding to the screen information from the server, and configures the screen by using the received content corresponding to the screen information.

16. The apparatus as claimed in claim 12, wherein the interface receives at least one selection or input for editing the screen from the user.

17. The apparatus as claimed in claim 16, wherein the interface further receives an input for setting a structure, an arrangement, or a design of the screen to be suitable for a desire, a hobby, a taste, an age, and a personality of the user.

18. The apparatus as claimed in claim 17, wherein the interface further receives a selection or an input for at least one of a basic background screen for each of a plurality of nations, a favorite background screen, an age group of a user, a gender, favorite contents, and numbers of the contents.

19. The apparatus as claimed in claim 11, wherein the display unit displays at least one content corresponding to the stored screen information.

20. A non-transitory computer readable storage medium for storing a program including commands for configuring a screen of a mobile terminal, the medium comprises:
a first set of commands for displaying an interface for configuring a screen of the mobile terminal;
a second set of command for receiving, through the displayed interface, at least one input for configuring the screen to be suitable for a user;
a third set of commands for configuring a screen of the mobile terminal corresponding to the received at least one input; and
a fourth set of commands for displaying the configured screen.

21. The non-transitory computer readable storage medium as claimed in claim 20, further comprising a fifth set of commands for storing screen information set by the input for configuring the screen,
wherein the screen information is generated by the received at least one input.

22. The non-transitory computer readable storage medium as claimed in claim 21, further comprising a sixth set of commands for reading, upon determining that the received input for configuring the screen is not identical to previously-stored screen information, contents corresponding to the screen information stored by a storage unit.

23. The non-transitory computer readable storage medium as claimed in claim 21, further comprising a seventh set of commands for requesting, from a server, upon determining that the received input for configuring the screen setting is not identical to the previously-stored screen information, contents corresponding to the screen information, for receiving the requested content corresponding to the screen information from the server, and for configuring the screen by using the received content corresponding to the screen information.
